(19) United States
(12) Patent Application Publication
(10) Pub. No.: US 2016/0204994 A1
(43) Pub. Date: Jul. 14, 2016

(54) METHOD, COMPUTER PROGRAM AND APPARATUS FOR PROVIDING A SERVICE RELATING TO A CONSUMER PACKAGE

(71) Applicant: SOLVER PALVELUT OY, Inkeroinen (FI)

(72) Inventor: Mauri REINILÄ, Jarvenpaa (FI)

(21) Appl. No.: 15/077,991

(22) Filed: Mar. 23, 2016

Related U.S. Application Data
(63) Continuation of application No. 13/982,939, filed on Sep. 27, 2013.

(30) Foreign Application Priority Data
Jan. 31, 2011 (FI) 20115096

(51) Int. Cl. H04L 12/24

(52) U.S. Cl. CPC H04L 41/50

(57) ABSTRACT

According to one aspect of the invention, there is provided a method including at least: receiving a registration of a user to a package media service; assigning a user identifier to the user; receiving a first unique identifier of a consumer package; associating the first unique identifier with the user identifier; associating an action with the combination of the user identifier and the first unique identifier of the consumer package; and initiating the action to the user by the package media service via the data communication network, when the package media service subsequently receives the first unique identifier of the consumer package via the data communication network.

### CROSS REFERENCE TO RELATED APPLICATION

The present application is a continuation application of U.S. patent application Ser. No. 13/982,939, filed Sep. 27, 2013, which is the National Phase application of International Application No. PCT/FI2012/050087, filed Jan. 31, 2012, which claims priority to Finland Patent No. 125662, filed on Jan. 31, 2011. The disclosures of the above listed application are hereby incorporated by reference herein in their entirety.

### TECHNICAL FIELD

The present invention relates to users and consumer packages. Especially, there is provided a method, a computer program and an apparatus for providing at least one service relating to at least one consumer package.

### DESCRIPTION OF THE RELATED ART

Consumer packages (i.e. the package surrounding the actual content) include various pieces of information that are intended to describe the contents of the consumer packages in more detail. Some of the information is intended for a consumer, e.g. information relating to the content of a package, product description etc. Similarly, some of the information is meant for other parties, e.g. for a store, manufacturer of the product, and it typically includes e.g. numerical information or bar codes.

Some consumer packages have been equipped with information with which a user is able to utilise such a package in a new way. A package may be provided with a special code, e.g. a two-dimensional code. A typical arrangement is that a software application running on a computer or an application used via the Internet is used to capture video image via a camera connected to the computer, e.g. via a built-in camera of a laptop computer. When the special code (e.g. held by the user or put on a table) is detected by the camera, the application builds a special virtual environment relating to the special code on the screen of the computer. A term Augmented Reality (AR) is often used in this context. The special environment may present two or three-dimensional information to the user. The presented information may be static by its nature, e.g. a three-dimensional product demonstration. In another embodiment, the presented information may be interactive, e.g. a game to be played by the user. In the above examples, the special code gives as a result always the same special environment with the application.

Based on the above, there is an obvious need for a solution which offers a more flexible and customizable way to provide various services to a user based on a special code on a consumer package.

### SUMMARY

According to one aspect of the invention, there is provided a method including at least: receiving, by the processor, with a package media service via a data communication network, a registration of a user to a package media service; assigning, by the processor, in the package media service, a user identifier to the user; receiving, by the processor, with the package media service from the user via the data communication network, a first unique identifier of a consumer package, wherein the first unique identifier of the consumer package is unique among all consumer packages and identifies a single consumer package; associating, by the processor, in the package media service, the first unique identifier with the user identifier; associating, by the processor, in the package media service, an action with the combination of the user identifier and the first unique identifier of the consumer package; and initiating, by the processor, in the package media service, the action to the user by the package media service via the data communication network, when the package media service subsequently receives the first unique identifier of the consumer package via the data communication network.

According to another aspect of the invention, there is provided an apparatus including at least: at least one processor; and at least one memory connected to the at least one processor, wherein the at least one memory comprises program codes configured to cause, with the at least one processor, the apparatus to: receive, via a data communication network, a registration of a user to a package media service; assign in the package media service a user identifier to the user; receive, from the user via the data communication network, a first unique identifier of a consumer package, wherein the first unique identifier of the consumer package is unique among all consumer packages and identifies a single consumer package; associate, in the package media service, the first unique identifier with the user identifier; associate, in the package media service, an action with the combination of the user identifier and the first unique identifier of the consumer package; and initiate the action to the user by the package media service via the data communication network, when the package media service subsequently receives the first unique identifier of the consumer package via the data communication network.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 discloses a block diagram illustrating the method according to one embodiment of the invention;

FIG. 2 discloses a simplified block diagram of a package media service according to one embodiment of the invention;

FIG. 3A discloses a block diagram illustrating user profiles according to one embodiment of the invention;

FIG. 3B discloses a block diagram illustrating user profiles according to one embodiment of the invention; and

FIG. 4 discloses an apparatus according to one embodiment of the invention.

### DETAILED DESCRIPTION

Reference will now be made in detail to the embodiments of the present invention, examples of which are illustrated in the accompanying drawings.

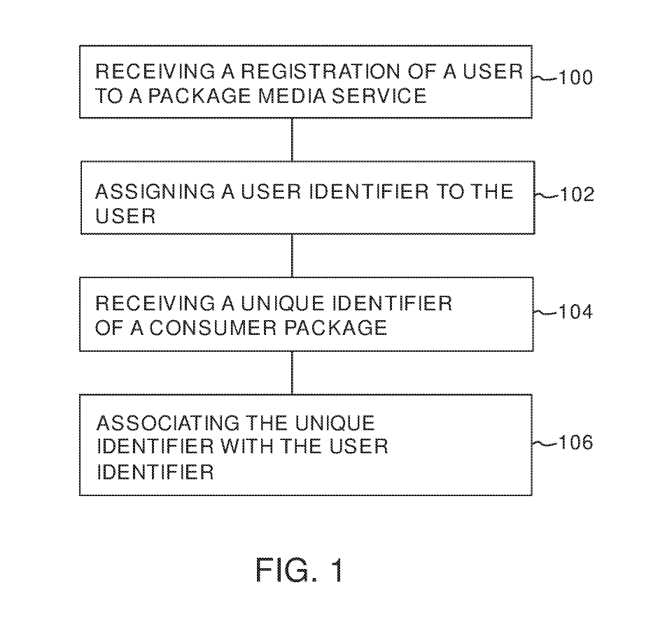

FIG. 1 discloses a block diagram illustrating the method according to one embodiment of the invention. I

[symbol]

In step 100, a package media service receives via a data communication network a registration of a user. In one embodiment, the package media service is a software application that is running on a server computer. The server computer is connected to a data communication network (e.g. the Internet) and is able to receive and transmit data to and from the data communication network. One purpose of the package media service is to establish links between users and consumer packages that the users have bought or received. When a user registers at the package media service, various pieces of information may be collected from the user. The gathered information about the user is stored in a user profile relating to the user. As part of the user profile, the package media service assigns the user a user identifier (step 102). The user identifier may be any appropriate identifier that uniquely identifies the user in the package media service. The user may registrate directly to the package media service. In another embodiment, the user may registrate to the package media service indirectly via another service (e.g. Facebook), web page or application.

In step 104, the package media service receives from the user a unique identifier of a consumer package. In the invention, each consumer package has been equipped with a unique identifier that identifies the package. This means that, for example, if a company has produced 10000 cereal packages, although each package may seem identical with other similar packages, each of them carries a unique identifier. The unique identifier is e.g. a two-dimensional code or any other feature or identifier on a package that uniquely identifies the package.

For realizing the receiving step, in one embodiment, the user may be provided with a software application that is installed in the user's computer. In another embodiment, the application is a flash application that is run on a web browser via the Internet. The application uses a camera of the user's computer. The camera may be a built-in camera of the (laptop) computer or a separate camera connected to the user's computer. The user shows the product package to the camera, and the application is programmed to find the unique identifier from the received product package image. The unique identifier of the product package is then sent to the package media service with the application. Since the user has not before used the application to transmit this identifier to the package media service, the package media service associates the unique identifier with the user identifier (step 106). The association thus creates a link between a user and a single identifiable product package. In other embodiments, any other possible ways to provide the unique identifier to the package media service can be used.

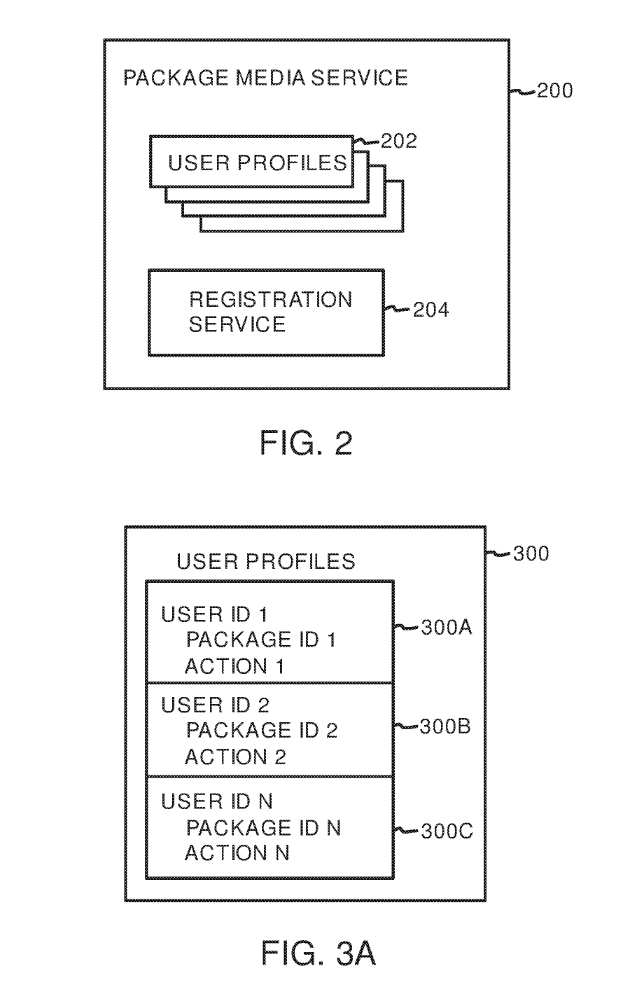

FIG. 2 discloses a simplified block diagram of a package media service (200) according to one embodiment of the invention. The package media service (200) may be a software application running on a server connected to a data communication network, e.g. the Internet. Users are able to register to the package media service (200) via the Internet using a registration service (204). The package media service (200) includes a separate user profile (202) for each registered user.

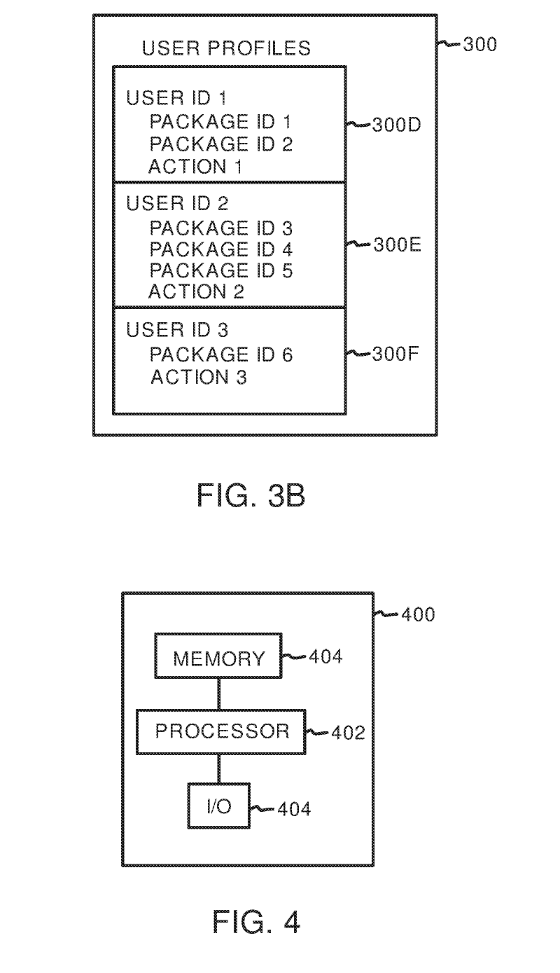

FIG. 3A discloses a block diagram illustrating user profiles according to one embodiment of the invention. In this embodiment, in each user profile (300, 300A, 300B, 300C) a user identifier is associated with only one unique package identifier. For example, a user profile (300A) identified by user ID 1 is associated with a package ID 1. In this embodiment, the user has associated also an action (action 1) with the user ID 1/package ID 1 combination. A user profile (300B) identified by user ID 2 is associated with a package ID 2. The user has associated an action (action 2) with the user ID 2/package ID 2 combination. Actions relating to the user identifiers and package identifiers are explained in more detail below.

FIG. 3B discloses a block diagram illustrating user profiles (300D, 300E, 300F) according to another embodiment of the invention. In this embodiment, a user profile (300D) identified by user ID 3 has only one package identifier (package identifier 6) associated with the user identifier. User profiles (300D, 300E) identified by user IDs 1 and 2 have several associated package identifiers. In this embodiment, although the user profiles (300D, 300E) have multiple associated package identifiers, only one action (action 1 or action 2) is associated with the identifiers in both user profiles. Actions relating to the user identifiers and package identifiers are explained in more detail below.

In one embodiment, a user profile disclosed in FIG. 3A or 3B may include information also from other profiles relating to the same user. The other profiles refer e.g. to the user's profile in other web services, e.g. Facebook, Twitter etc. The acquisition of the additional profile information may be automatic if the user has given permission to it and provided the package media service e.g. with login information to the other profiles. In any case, in one embodiment, user profile information from other profiles is combined to the user profile information in the package media service only with permission from the user.

The user profiles disclosed in FIGS. 3A and 3B includes an action associated with the user identifier and the package identifier. In one embodiment, the package media service allows a registered user to link an action to be associated with the user identifier/package identifier pair. When, after the package identifier and the user identifier have been associated with each other, and the package media service again receives from the user the package identifier that uniquely identifies the package (e.g. when the user has logged in to the package media service), the package media service may automatically activate the user-determined action. The action may take any appropriate form. Some possible alternatives are disclosed below:
activating media content, e.g. a video file, a sound file etc.
activating a predetermined service, e.g. opening a web page etc.
establishing a connection, e.g. a speech connection or a video connection with a predetermined recipient etc.

In one embodiment of FIGS. 3A and 3B, user profile information may be used to gather information about the users and about the packages associated with the users. Each time a user associates a product package to his user profile, the association produces various pieces of information. This information may include one or more of the following:
what was bought
who bought the package
when the package was bought
where does the user live,
sex (male/female),
age

The collected user profile information can be made use of in several ways. For example, the collected information may be used in marketing and advertising purposes. Other possibilities for utilising the user profile information include various reports and forecasts.

In one embodiment of FIG. 3B, as disclosed, several separate package identifiers have been associated with the user ID 2 (300E). In one embodiment, the action 2 is carried out when a user-selected package identifier (package ID 3, ID 4 or ID 5) is received from the user when the package identifier has already previously been associated with the user identifier. In another embodiment, the user has determined that when user-selected package identifiers (e.g. package ID 3 and package ID 4) are at the same time received from the user when the package identifiers have already previously been associated with the user identifier, only then the action 2 is carried out. In other words, the user has e.g. to show two separate product packages to the camera and the package media service identifies package identifiers of the product packages from the image provided by the camera. Only after identifying both package identifiers the action 2 set by the user is carried out.

FIG. 4 discloses an apparatus (400) according to one embodiment of the invention. The apparatus (400) comprises at least one processor (402) and at least one memory (404) connected to the at least on processor (402). The apparatus (400) further comprises input/output means (406) receiving and sending information.

The exemplary embodiments can include, for example, any suitable servers, workstations, PCs, laptop computers, personal digital assistants (PDAs), Internet appliances, handheld devices, cellular telephones, smart phones, wireless devices, other devices, and the like, capable of performing the processes of the exemplary embodiments. The devices and subsystems of the exemplary embodiments can communicate with each other using any suitable protocol and can be implemented using one or more programmed computer systems or devices.

It is to be understood that the exemplary embodiments are for exemplary purposes, as many variations of the specific hardware used to implement the exemplary embodiments are possible, as will be appreciated by those skilled in the hardware and/or software art(s). For example, the functionality of one or more of the components of the exemplary embodiments can be implemented via one or more hardware and/or software devices.

The exemplary embodiments can store information relating to various processes described herein. This information can be stored in one or more memories, such as a hard disk, optical disk, magneto-optical disk, RAM, and the like. One or more databases can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be conveniently implemented using one or more general purpose processors, microprocessors, digital signal processors, microcontrollers, and the like, programmed according to the teachings of the exemplary embodiments of the present inventions, as will be appreciated by those skilled in the computer and/or software art(s). Appropriate software can be readily prepared by programmers of ordinary skill based on the teachings of the exemplary embodiments, as will be appreciated by those skilled in the software art. In addition, the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware and/or software.

Stored on any one or on a combination of computer readable media, the exemplary embodiments of the present inventions can include software for controlling the components of the exemplary embodiments, for driving the components of the exemplary embodiments, for enabling the components of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the components of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Common forms of computer-readable media can include, for example, a floppy disk, a flexible disk, hard disk, magnetic tape, any other suitable magnetic medium, a CD-ROM, CDR, CD-RW, DVD, DVD-ROM, DVD±RW, DVD±R, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

1. A method of an apparatus comprising at least one processor, the method comprising:
receiving, by the processor, with a package media service via a data communication network, a registration of a user to a package media service;
assigning, by the processor, in the package media service, a user identifier to the user;
receiving, by the processor, with the package media service from the user via the data communication network, a first unique identifier of a consumer package, wherein the first unique identifier of the consumer package is unique among all consumer packages and identifies a single consumer package;
associating, by the processor, in the package media service, the first unique identifier with the user identifier;
associating, by the processor, in the package media service, an action with the combination of the user identifier and the first unique identifier of the consumer package; and
initiating, by the processor, in the package media service, the action to the user by the package media service via the data communication network, when the package media service subsequently receives the first unique identifier of the consumer package via the data communication network.

2. The method of claim 1, further comprising:
receiving, by the processor, with the package media service from the user, a second unique identifier of another consumer package;
associating, by the processor, in the package media service, the second unique identifier with the user identifier.

3. The method of claim 1, further comprising:
activating, by the processor, a predetermined service for the user when receiving the first and/or second unique identifier again from the user.

4. The method of claim 1, further comprising:
activating, by the processor, media content for the user when receiving the first and/or second unique identifier again from the user.

5. The method of claim 1, further comprising:
associating, by the processor, contact information of at least one recipient with the first and/or second unique identifier.

6. The method of claim 5, further comprising:
establishing, by the processor, a connection towards the at least one recipient when receiving the first and/or second unique identifier again from the user.

7. The method of claim 6, wherein the connection comprises one of the following:
a speech connection; and
a video connection.

8. A non-transitory computer-readable medium storing program code configured to perform the method of claim 1 when executed on a processing device.

9. A computer program as claimed in claim 8, the computer program comprises program code, which is configured to a computer readable device.

10. An apparatus, comprising:
at least one processor; and
at least one memory connected to the at least one processor, wherein the at least one memory comprises program codes configured to cause, with the at least one processor, the apparatus to:
receive, via a data communication network, a registration of a user to a package media service;
assign in the package media service a user identifier to the user;
receive, from the user via the data communication network, a first unique identifier of a consumer package, wherein the first unique identifier of the consumer package is unique among all consumer packages and identifies a single consumer package;
associate, in the package media service, the first unique identifier with the user identifier;
associate, in the package media service, an action with the combination of the user identifier and the first unique identifier of the consumer package; and
initiate the action to the user by the package media service via the data communication network, when the package media service subsequently receives the first unique identifier of the consumer package via the data communication network.
